(19) United States
(12) Patent Application Publication
(10) Pub. No.: US 2022/0338312 A1
(43) Pub. Date: Oct. 20, 2022

(54) CLOSED-LOOP CONTROL OF AN INDUCTION HEATING SYSTEM IN A GENERATIVE MANUFACTURING PROCESS

(71) Applicant: Siemens Energy Global GmbH & Co. KG, Munich, Bayern (DE)

(72) Inventors: Matthias Goldammer, Munchen (DE); Henning Hanebuth, Pliening OT Gelting (DE)

(73) Assignee: Siemens Energy Global GmbH & Co. KG, Munich, Bayern (DE)

(21) Appl. No.: 17/640,533

(22) PCT Filed: Sep. 8, 2020
(86) PCT No.: PCT/EP2020/075067

§ 371 Date: Mar. 4, 2022

(30) Foreign Application Priority Data
Sep. 18, 2019 (EP) 19198109.1

(51) Int. Cl. H05B 6/06; H05B 6/42

(52) U.S. Cl. CPC H05B 6/06; H05B 6/42; H05B 6/101

(57) ABSTRACT

A method which controls a heating power induced in a component in a generative manufacturing process wherein the heating power is induced by an induction heating system. The closed-loop control method is based on the concept of indirectly determining the previously unknown heating power which is actually induced in component. This is accomplished by the power losses, which substantially consist of waste heat to the cooling liquid and to the other surroundings, being deducted from the electrical power that is inserted into the induction heating system (specifically, the electrical power of the induction generator). The power losses are calculated, insofar as is possible; alternatively, they are also estimated.

### CROSS REFERENCE TO RELATED APPLICATIONS

This application is the US National Stage of International Application No. PCT/EP2020/075067 filed 8 Sep. 2020, and claims the benefit thereof. The International Application claims the benefit of European Application No. EP19198109 filed 18 Sep. 2019. All of the applications are incorporated by reference herein in their entirety.

### FIELD OF INVENTION

The invention relates to the closed-loop control of an induction heating system in a generative manufacturing process. It relates in particular to the closed-loop control of a heating power induced in a component. The invention also relates to a closed-loop control unit for an induction heating system which is designed to carry out such a method.

### BACKGROUND OF INVENTION

To improve the material properties in a generative manufacturing process, for example by means of selective laser melting, an additional heating unit that allows better control of the heating up and cooling down of the material may be used. Induction heating systems are well suited for this, since the heat is only introduced into the regions that have already been worked and does not affect the unworked powder. However, induction heating systems only act locally, to be specific are confined to a region around the electrical conductor of the induction coil, as a result of which a mechanical displacement of the induction coil to the location to be heated in each case is necessary.

The electrical properties of the heating system, in particular its inductance and its ohmic resistance, depend in this case both on the position (changing of the impedance due to differing length of conduction) and the component under the coil (eddy currents in the coil). As a result, both the maximum possible power that the induction generator can make available and the efficiency of the induction heating change. The closed-loop control of the temperature cannot make any allowance for these different heating rates and must therefore be operated with more conservative parameters than would actually be possible.

In induction heating systems that are currently in use and undergoing development, the heating power that is actually present in the component is unknown. A closed-loop control of the electrical power predetermined by the induction generator is consequently not possible on the basis of the actual heating power in the component.

### SUMMARY OF INVENTION

An object of the present invention is to improve this. It is intended in particular to develop a closed-loop control method for controlling the heating power induced in the component.

The present invention, as it is disclosed in the independent claims, achieves this object. The dependent claims reproduce particularly advantageous embodiments of the invention.

Accordingly, a method which controls the heating power induced in a component in a generative manufacturing process is proposed. The heating power is induced by an induction heating system. The induction heating system has an induction generator and an induction coil. The induction coil is connected to the induction generator by electrical leads. The leads are cooled with the aid of a cooling liquid.

The closed-loop control method comprises the following steps: determining the heating power actually induced in the component; comparing the actual heating power with a target value; in the event of a deviation of the actual heating power from the target value that is greater than a predetermined threshold value: changing the electrical power predetermined by the induction generator in such a way that the deviation between the actual heating power and the target value is less than the predetermined threshold value.

In this case, the determination of the heating power actually induced in the component comprises the following substeps: detecting the electrical power predetermined by the induction generator; subtracting the thermal power that is given off as waste heat to the cooling liquid of the leads; subtracting the thermal power that is given off by the leads to the remaining surroundings, that is to say apart from the cooling liquid.

The closed-loop control method according to the invention is therefore based on the idea of indirectly determining the previously unknown heating power actually induced in the component. This is accomplished by subtracting the power losses, consisting substantially of waste heat to the cooling liquid and to the rest of the surroundings, from electrical power that is introduced into the induction heating system (to be specific the electrical power of the induction generator). As far as possible, the power losses are calculated; alternatively, they may also be estimated.

The electrical power predetermined by the induction generator can generally be read out and used relatively easily.

The thermal power that is given off as waste heat to the cooling liquid of the leads may be calculated for example by way of the flow rate of the cooling liquid through the cooling lines and the temperature difference between the inflow and the outflow: the temperature difference can be converted into the waste heat taken up by the cooling liquid; the flow rate can be used to deduce the thermal power that is given off.

Even if, in an induction heating system, generally all of the accessible regions of the electrical leads are liquid-cooled, experience shows that it is nevertheless not possible to avoid there also being regions in which waste heat is given off via the surroundings, in particular via the air. This can advantageously be estimated by way of temperature sensors that are installed at the corresponding locations.

If the induction heating system has further components at which waste heat is given off, allowance for these should also be made in the determination of the heating power actually induced in the component. Generally, a transformer is interposed for example between the induction generator and the oscillating circuit that the induction coil forms with one or more capacitors. The transformer has the function of converting the relatively high voltage of the induction generator into a comparatively low voltage, which is accompanied by an increase in the current strength at the output of the transformer. This has the advantage that a relatively low (effective) alternating voltage is present at the output of the transformer, in the so-called working circuit of the induction heating system, but there is a high current strength. The high current strength that flows through the induction coil is important to provide high heating power in the component, induced by the induction coil.

Such a transformer also always produces ohmic losses, that is to say waste heat. These can either be removed by the cooling system that also cools the leads up to the induction coil. Then allowance for these heat losses is already included in the allowance for the thermal power that is given off as waste heat to the cooling liquid of the leads. If, however, the transformer has a cooling system of its own, allowance for the thermal power given off here should also be made in the determination of the heating power actually induced in the component.

The induction heating system has in particular a displacing unit, which makes possible the displacement of the induction coil in relation to the component. The displacing unit comprises for example one or more rails on which a slide can be moved along. The electrical contact between the rails and the slide is for example provided by a sliding contact. Such a system made up of rails and a slide may be provided in two directions perpendicular to one another, so that a displacement of the induction coil over a surface area is possible.

Advantageously, the overall time for carrying out the steps of the closed-loop control method is at most 1 s (second), preferably at most 200 ms (milliseconds). The overall time in this case comprises the time for the determination of the heating power actually induced in the component, that is to say the detection of the electrical power predetermined by the induction generator, the subtraction of the thermal power that is given off as waste heat to the cooling liquid of the leads, and the subtraction of the thermal power that is given off by the leads to the rest of the surroundings. This is followed by a comparison of the actual heating power with a target value, which however generally should not take up any appreciable amount of time. The possibly necessary adaptation, that is to say changing, of the power of the induction generator also takes place quickly. It generally takes somewhat longer until the power actually induced in the component reaches the desired value; this time is not included in the specified time period of 1 s.

A quick determination of the induced heating power is desirable, since then location-dependent information with respect to the heat actually induced in the component can be obtained without the displacement of the induction coil or the generative manufacturing process itself having to be impaired, in particular slowed down.

It is furthermore also advantageous if, in a further step, the heating power actually induced in the component in dependence on the position of the induction coil in relation to the component is stored on a memory unit.

In addition to improved reactive closed-loop control, the position-dependent storage of the power data also makes possible direct pre-control of the heating for a quickest-possible heating-up rate.

The data are stored position-dependently and can be included in the control as an input variable for the next layer to be worked. Since the induction heating not only acts on the current layer but has a frequency-dependent penetration depth in the range of millimeters, the data of the previous layer can be used for controlling the next layer. A further improvement is achieved if the penetration depth of the induction heating makes allowance for the data of a number of layers (for example by depth-weighted averaging). However, the short period of time in which this calculation should, as far as possible, be performed represents a challenge in practice.

In the case of mass production of components, the data may also be stored and additionally make possible an off-line optimization of the closed-loop control of the induction heating system.

Finally, the invention comprises not only the closed-loop control method itself, but also a closed-loop control unit for an induction heating system that is designed for carrying out the said method.

The invention is illustrated below on the basis of the appended figures. The figures show embodiments selected by way of example and schematically, without restriction of the claimed scope of protection.

### BRIEF DESCRIPTION OF THE DRAWINGS

In the figures:

FIG. 1 shows an apparatus for the generative manufacturing of a component with an induction heating device; and

FIG. 2 shows a flow diagram of the closed-loop control method of an induction heating system in a generative manufacturing process.

### DETAILED DESCRIPTION OF INVENTION

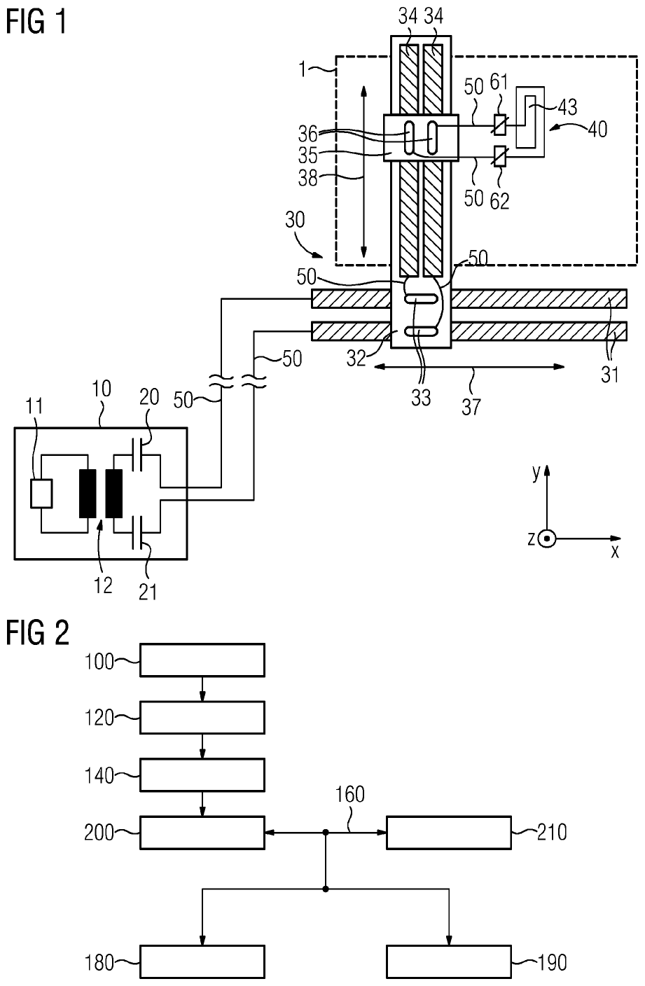

FIG. 1 (also referred to as FIG. 1) shows an apparatus for the generative manufacturing of a component 1 with an induction heating device. The apparatus comprises a platform, which is intended for a metallic material in the form of a powder or wire to be applied to it layer by layer, and also a primary heating device, which is designed to melt a metallic material in the form of a powder or wire applied to the platform. These component parts of the apparatus are standard component parts of an installation for generative component manufacturing (also: additive manufacturing or 3D printing) and are not shown in FIG. 1 for reasons of overall clarity. Their design and connection to one another are well known to a person skilled in the art in the field of generative manufacturing, in particular selective laser melting.

The apparatus has furthermore an induction heating device for heating the material. Both the pre-heating of the not yet melted material and the post-treatment of the already melted material are possible with the induction heating device. Also possible in principle is inductive heating of the metallic material during the melting by means of for example a laser-beam or electron-beam source.

The induction heating device has an alternating voltage supply device 10, which consists of an induction generator 11 and a transformer 12. The induction generator 11 generates alternating voltage with an effective voltage of several hundred volts up to several kilovolts. The current strength is in this case moderate and is for example between 10 A and 100 A. In order to achieve a high heating power through the induction coil, it must be flowed through by a current of a high strength, which is in particular higher than 100 A. For this reason, a transformer 12 is connected to the induction generator 11. The transformer 12 converts the high voltage of the induction generator 11 into a lower voltage, which has the direct consequence of an increase in the current strength in the circuit at the output of the transformer 12. The circuit at the input of the transformer 12 is also referred to as the “generator circuit”; the circuit at the output of the transformer 12 is also referred to as the “working circuit”.

The alternating voltage supply device 10 is connected to a displacing unit 30 by means of electrical lines, which in this application are also referred to as leads 50. The displacing unit 30 has the purpose of making the induction coil 40 adjoining it displaceable with respect to a stationary component 1. For this, a first slide 32 and a second slide 35 can each be activated by means of a control device. The control device for the displacing unit 30 is not shown in FIG. 1 for reasons of overall clarity and is also not discussed any more specifically in this description, since it does not concern the essence of this invention.

The first slide 32 is located on a first pair of rails 31 by means of two first sliding contacts 33. The sliding contacts 33 are for example made of an electrically highly conductive metal, as are the two rails of the first pair of rails 31. Copper may be mentioned for example as a suitable material for the sliding contacts 33 and the pair of rails 31. The first sliding contacts 33 are for their part in turn connected to a second pair of rails 34 by means of electrical conductors 50. The second pair of rails 34 forms the supporting surface for the second slide 35, the second sliding contacts 36 of which are electrically connected to the rails of the second pair of rails 34. The second sliding contacts 36 are connected to the induction coil 40 by means of leads 50. The first slide 32 is movable back and forth along a first displacement direction 37 (here correspondingly the x direction); the second slide 35 is movable back and forth along a second displacement direction 38 (here correspondingly the y direction). For the induction coil 40, it follows from this that it is displaceable in a region (or: area) defined by the displacing unit 30.

The induction coil 40 (and also for example the alternating voltage supply device 10) is not shown to scale in FIG. 1 with respect to the other components. In most actual cases, it will be much smaller. For the sake of overall clarity, however, it is shown in FIG. 1 as a large, double-wound coil. The induction coil in this case defines by its coil interior a window 43, through which a laser beam can advantageously pass onto the material to be worked.

A further component part of the induction heating system is a capacitor 20, which together with the induction coil 40 forms a series oscillating circuit, also referred to as a series resonant circuit or RCL resonant circuit. On account of the high currents that flow through the induction coil 40, the inductance of the coil is high and the capacitance of the capacitor 20 must be chosen to be correspondingly great. A certain structural size and weight of the capacitor 20 follow from this. The capacitor 20 has consequently been integrated in the alternating voltage supply device 10, since the alternating voltage supply device 10 with the induction generator 11 and the transformer 12 would in any case take up a lot of space and also make up a lot of weight.

In the embodiment shown in FIG. 1, the induction heating system also has a second capacitor, which is also referred to as an additional capacitor 21. This substantially serves as an extra capacitor to provide more flexibility for setting the capacitance of the oscillating circuit.

The induction generator 11, the transformer 12, the capacitor 20 and the additional capacitor 21 are surrounded by a common housing for protection.

Furthermore, the induction heating system has a first temperature sensor 61 and a second temperature sensor 62. Both temperature sensors 61, 62 are placed at the leads 50 between the second slide 35 and the induction coil. The reason for this is that in this (short) part of the electrical leads 50 (by way of example) it is suspected that there is insufficient water cooling of the leads 50. In order to detect quantitatively the thermal power that is given off to the surroundings, that is to say the air, the temperature sensors 61, 62 measure the temperature of the air. A comparison of the measured temperature with the room temperature allows the thermal power that is given off to be deduced, and this is subtracted from the electrical power initially fed in by the induction generator 11.

FIG. 2 (also referred to as FIG. 2) shows a flow diagram of the method according to the invention for the closed-loop control of the heating power of an induction heating system that is induced in the component 1.

In a first step 100, the electrical power fed in (in other words: predetermined) by the induction generator 11 is detected. In the simplest case, the value of the power that is read off at the induction generator 11 may simply be taken for this. Alternatively, the voltage and current strength in the generator circuit may be separately measured and the power fed in by the induction generator 11 calculated from this.

In a second step 120, the thermal power that is given off as waste heat to the cooling liquid of the leads 50 is subtracted from this. In many practical cases, the induction heating system has a single cooling system for all of the leads 50. This means on the one hand electrical lines that connect the alternating voltage supply device 10 to the displacing unit 30. They may be fixed lines, for example copper lines. They may also be flexible cables, the outside of which is flowed around by cooling water. On the other hand, between the displacing unit 30 and the induction coil 40 there are also leads, which are generally liquid-cooled. Finally, individual components of the displacing unit 30, in particular the pairs of rails 31, 34, and also the connection of the first sliding contacts 33 to the second pair of rails 34 and the connection of the second sliding contacts 36 to the induction coil 40 are also liquid-cooled.

The difference between the temperature of the inflow and the outflow of the cooling liquid and the flow rate through the lines of the cooling system can be used as a basis for calculating the thermal power that is introduced into the cooling liquid by the leads 50, and is consequently lost for the heating power of the component 1.

In a third step 140, any further losses of the induction heating system that are given off in the form of waste heat to the remaining surroundings are detected and subtracted from the originally fed-in electrical power. For estimating these losses, temperature sensors are advantageously placed in the regions concerned, as is shown by the two temperature sensors 61, 62 in the setup given by way of example in FIG. 1.

As a result, an estimate (in other words: determination) is obtained for the heating power introduced into the component 1.

In a fourth step 160, this value 200 is compared with a target value 210. The target value 210 represents the induced heating power that is aimed for or desired or required.

If the estimated actual heating power 200 in the component 1 deviates from the target value 210 by an amount that is greater than a predetermined threshold value, in a last step 180 the electrical power that is fed into the system by the induction generator 11 is changed (either increased or reduced). If, on the other hand, the estimated actual heating power 200 in the component 1 deviates from the target value 210 by an amount that is less than or equal to a predetermined threshold value, in a last step 190 nothing is done, in particular the electrical power of the induction generator 11 is not adapted.

With the aid of this method, a positionally dependent determination of the heating power actually induced in the component is possible. This can be used in order for the first time to adapt the heating power during the generative manufacturing process reactively and/or predictively. Furthermore, conclusions concerning the efficiency of the induction heating system can be obtained directly and dynamically.

1. A method for closed-loop control of a heating power of an induction heating system that is induced in a component in a generative manufacturing process, wherein the induction heating system has an induction generator and an induction coil and the induction coil is connected to the induction generator by electrical leads cooled by a cooling liquid, the method comprising:
determining an actual heating power actually induced in the component;
comparing the actual heating power with a target value; and
in the event of a deviation of the actual heating power from the target value that is greater than a predetermined threshold value, changing an electrical power predetermined by the induction generator in such a way that the deviation between the actual heating power and the target value is less than the predetermined threshold value,
wherein the determination of the actual heating power actually induced in the component comprises:
detecting the electrical power predetermined by the induction generator;
subtracting a thermal power that is given off as waste heat to the cooling liquid of the leads, and
subtracting the thermal power that is given off by the leads to the remaining surroundings.

2. The method as claimed in claim 1,
wherein the induction heating system also has a transformer and the transformer takes up a voltage generated by the induction generator as an input alternating voltage and converts it into an output alternating voltage.

3. The method as claimed in claim 2,
wherein the transformer is likewise cooled, and
wherein the determination of the heating power actually induced in the component comprises:
subtracting the thermal power that is given off as waste heat to the cooling of the transformer.

4. The method as claimed in claim 1,
wherein the thermal power that is given off as waste heat to the cooling liquid of the leads is calculated by a flow rate of the cooling liquid through a cooling liquid system and a difference between a temperature of an inflow and a temperature of an outflow.

5. The method as claimed in claim 1,
wherein the thermal power that is given off by the leads to the surroundings, apart from the cooling liquid, is calculated on the basis of the measured values of temperature sensors, which are placed at corresponding locations on the leads.

6. The method as claimed in claim 1,
wherein an overall time for the determination of the heating power actually induced in the component is at most 1 s.

7. The method as claimed in claim 1,
wherein the induction heating system also has a displacing unit, which makes possible the displacement of the induction coil in relation to the component.

8. The method as claimed in claim 7,
wherein, in a further step, the heating power actually induced in the component in dependence on a position of the induction coil in relation to the component is stored on a memory unit.

9. A closed-loop control unit for an induction heating system,
wherein the control unit is adapted to carry out the method as claimed in claim 1.

10. The method as claimed in claim 6,
wherein the overall time for the determination of the heating power actually induced in the component is at most 200 ms.
